(19) United States
(12) Patent Application Publication
(10) Pub. No.: US 2026/0049923 A1
(43) Pub. Date: Feb. 19, 2026

(54) MICROPARTICLE MEASURING APPARATUS

(71) Applicant: ADVANTEST CORPORATION, Tokyo (JP)

(72) Inventors: Yasuharu IMAI, Tokyo (JP); Nobuei WASHIZU, Tokyo (JP)

(21) Appl. No.: 19/368,324

(22) Filed: Oct. 24, 2025

Related U.S. Application Data
(63) Continuation of application No. PCT/JP2024/016138, filed on Apr. 24, 2024.

(30) Foreign Application Priority Data
Apr. 25, 2023 (JP) 2023-071558

(51) Int. Cl. G01N 15/12; G01N 15/10

(52) U.S. Cl. CPC G01N 15/132; G01N 2015/1024; G01N 2015/1029; G01N 2015/135

(57) ABSTRACT

A pore-based device has a first liquid chamber and a second liquid chamber separated by a partition having a pore. A measuring instrument is structured to measure a current signal flowing between a first electrode provided in the first liquid chamber and a second electrode provided in the second liquid chamber. A pressure controller is structured to generate pressure difference between the first liquid chamber and the second liquid chamber. A tank is connected between a pump and the pore-based device. The pump is structured to remain stopped during the measurement.

### CROSS REFERENCE TO RELATED APPLICATIONS

This application is a continuation under 35 U.S.C. § 120 of PCT/JP2024/016138, filed Apr. 24, 2024, which is incorporated herein by reference, and which claimed priority to Japanese Application No. 2023-071558, filed Apr. 25, 2023. The present application likewise claims priority under 35 U.S.C. § 119 to Japanese Application No. 2023-071558, filed Apr. 25, 2023, the entire content of which is also incorporated herein by reference.

### BACKGROUND

### 1. Technical Field

The present disclosure relates to measurement for use with a pore-based device.

### 2. Description of the Related Art

A method for measuring particle size distribution, called electrical sensing zone method (based on the Coulter's principle), has been known. In this measurement method, an electrolyte solution that contains particles is allowed to pass through a pore called nanopore. During passage of each particle through the pore, the electrolyte solution in the pore will decrease the volume by an amount equivalent to the volume of the particle, thus increasing electric resistance of the pore. The volume (or, particle size) of the particle can therefore be determined, by measuring the electric resistance of the pore.

FIG. 1 is a block diagram illustrating a microparticle measuring apparatus 1R based on the electrical sensing zone method. The microparticle measuring apparatus 1R has a pore-based device 100, a measuring instrument 200R, and a data processor 300.

The inside of the pore-based device 100 is filled with an electrolyte solution 2 that contains particles 4 to be detected. The inside of the pore-based device 100 is separated by a pore chip 102 into two spaces, in which an electrode 106 and an electrode 108 are individually provided. Under potential difference generated between the electrode 106 and the electrode 108, an ion current flows between the electrodes, during which the particles 4 migrate from one space through the pore 104 into the other space while driven by electrophoresis.

The measuring instrument 200R generates a potential difference between the pair of electrodes 106 and 108, and acquires information correlated with resistivity Rp between the pair of electrodes. The measuring instrument 200R has a transimpedance amplifier 210, a voltage source 220, and a digitizer 230. The voltage source 220 is structured to generate potential difference Vb between the pair of electrodes 106 and 108. The potential difference Vb provides a driving force of electrophoresis, as well as a bias signal for measuring the resistivity Rp.

Between the pair of electrodes 106 and 108, there flows microcurrent Is which is inversely proportional to the resistivity of the pore 104.

Is=Vb/Rp (1)

The transimpedance amplifier 210 is structured to convert the microcurrent Is into a voltage signal Vs. Given a conversion gain as r, an equation below holds.

Vs=−r×Is (2)

Substitution of equation (1) into the equation (2) gives equation (3) below.

Vs=−Vb×r/Rp (3)

The digitizer 230 is structured to convert the voltage signal Vs into digital data Ds. The voltage signal Vs, which is inversely proportional to the resistivity Rp of the pore 104, is obtainable in this way, by using the measuring instrument 200R. The data processor 300 is structured to process the digital data Ds, and to analyze count, particle size or the like of the particles 4 contained in the electrolyte solution 2.

FIG. 2 is an exemplary waveform chart of the microcurrent Is measured with the measuring instrument 200R. Note that the ordinates and the abscissae of waveform charts and time charts referred to herein are appropriately enlarged or shrunk for easy understanding, and also the waveforms illustrated herein are simplified, exaggerated or emphasized for easy understanding.

During a short period of passage of each particle, the resistivity Rp of the pore 104 increases. The current Is therefore decreases in a pulsated manner, every time one particle passes. Amplitude of each pulse current correlates with the particle size.

The present inventors have examined use of a pump for driving a pore-based device. The pump generates pressure difference between the two liquid chambers in the pore-based device, thereby creating a flow in the solution, and causing the particles contained therein to pass through the pore.

The pressure generated by the pump is pulsating, and the pulsation affects the flow of the solution. The microcurrent to be measured is therefore affected by the pulsation of the pump, and this will degrade S/N of the particle measurement.

Microparticle measurement necessarily measures the microcurrent at a level of several tens of picoamperes to several tens of nanoamperes. In the measurement of microcurrent of this level, the pulsation of the pump may be a possible cause for significantly degrading measurement accuracy.

Note that this problem was uniquely recognized by the present inventors, and should not be regarded as a common recognition of those skilled in the art.

### SUMMARY

The present disclosure has been arrived at considering such circumstances.

One mode of the present disclosure relates to a microparticle measuring apparatus for use with a pore-based device. The pore-based device has a first liquid chamber and a second liquid chamber separated by a partition having a pore. The microparticle measuring apparatus has a measuring instrument structured to measure a current signal flowing between a first electrode provided in the first liquid chamber and a second electrode provided in the second liquid chamber; and a pressure controller structured to generate pressure difference between the first liquid chamber and the second liquid chamber. The pressure controller has a pump, and a tank connected between the pump and the pore-based device. The pump is structured to remain stopped during the measurement.

Note that also free combinations of these constituents, and any of the constituents and expressions exchanged among the method, apparatus, and system, are valid as the modes of the present disclosure. Also note that the description of this section does not describe all essential features of the invention, and thus also sub combinations of these features described may constitute the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram illustrating a microparticle measuring apparatus based on the electrical sensing zone method;

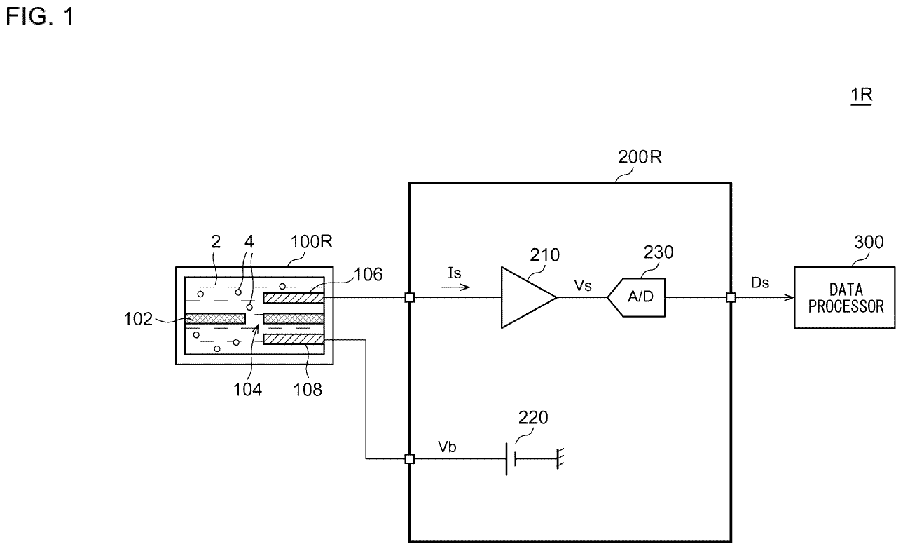

FIG. 2 is an exemplary waveform chart of microcurrent Is measured with a measuring instrument;

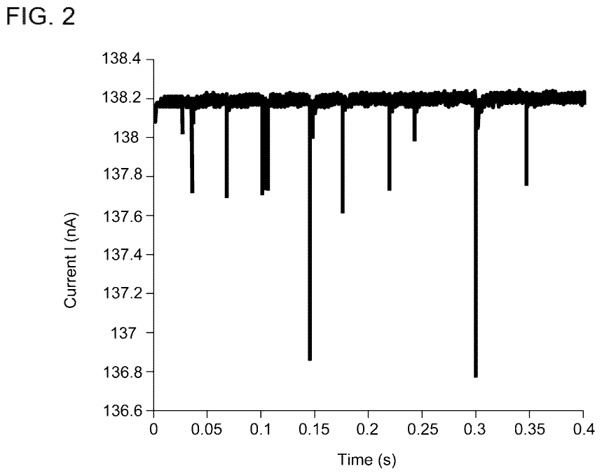

FIG. 3 is a diagram illustrating a microparticle measuring apparatus according to one embodiment;

FIG. 4 is a waveform chart (measurement result) of a current signal measured in an operation phase and in a stop phase of a pump;

FIG. 5A is a diagram illustrating a current waveform during pump operation (upper tier) and a spectrum thereof (lower tier), meanwhile FIG. 5B is a diagram illustrating a current waveform during pump stop (upper tier) and a spectrum thereof (lower tier);

FIG. 6 is a diagram illustrating relationships between pressure difference and count of passed particles;

FIG. 7 is a block diagram of the measuring instrument according to one Example;

FIG. 8 is a diagram illustrating a pressure controller according to one Example;

FIG. 9 is a diagram illustrating the pressure controller according to one Example; and

FIG. 10 is a diagram for explaining operations of the pressure controller illustrated in FIG. 9.

### DETAILED DESCRIPTION

### Outline of Embodiments

Some exemplary embodiments of the present disclosure will be outlined. This outline is intended for briefing some concepts of one or more embodiments, for the purpose of basic understanding of the embodiments, as an introduction before detailed description that follows, without limiting the scope of the invention or disclosure. This outline is not an extensive overview of all possible embodiments and is therefore intended neither to specify key elements of all embodiments, nor to delineate the scope of some or all of the embodiments. For convenience, the term “one embodiment” may be used to designate a single embodiment (Example or Modified Example), or a plurality of embodiments (Examples or Modified Examples) disclosed in the present specification.

One embodiment relates to a microparticle measuring apparatus for use with a pore-based device. The pore-based device has a first liquid chamber and a second liquid chamber separated by a partition having a pore. The microparticle measuring apparatus has a measuring instrument structured to measure a current signal flowing between a first electrode provided in the first liquid chamber and a second electrode provided in the second liquid chamber; and a pressure controller structured to generate pressure difference between the first liquid chamber and the second liquid chamber. The pressure controller has a pump, and a tank connected between the pump and the pore-based device. The pump is structured to remain stopped during the measurement.

This structure accumulates pressure in the tank prior to the measurement, and uses the energy accumulated in the tank for operating the pore-based device during the measurement. Since the pump is stopped during the measurement, the pressure applied to the solution in the pore-based device is exempt from the pulsation. This enables pulsation-free measurement and can improve the measurement accuracy.

In one embodiment, the pressure controller may further include a sensor structured to measure the pressure in the tank. The microparticle measuring apparatus may further include a controller structured to control the pump in accordance with an output of the sensor. The controller may be structured to operate the pump prior to the measurement, to stop the pump when the pressure detected by the sensor reaches a predetermined value, and to start the measurement after the pump is stopped.

In one embodiment, the pressure controller may be structured to reverse a direction of the pressure between the first liquid chamber and the second liquid chamber. This structure enables the microparticles to travel back and forth between the first liquid chamber and the second liquid chamber. This enables a large number of microparticles to pass through the pore, even in a situation only with a small number of microparticles, thereby enabling acquisition of data sufficient for estimating the particle size.

In one embodiment, the measuring instrument may have a transimpedance amplifier structured to convert the current signal into a voltage signal, and a digitizer structured to convert an output of the transimpedance amplifier into a digital signal.

### Embodiments

A preferred embodiment will be explained below, referring to the attached drawings. All similar or equivalent constituents, members and processes illustrated in the individual drawings will be given same reference numerals, so as to properly avoid redundant explanations. The embodiment is merely illustrative and is not restrictive about the invention. All features and combinations thereof described in the embodiment are not always necessarily essential to the present invention.

In the present specification, a “state in which member A is coupled to member B” includes a case where the member A and the member B are physically and directly coupled, and a case where the member A and the member B are indirectly coupled via some other member that does not substantially affect the electrically coupled state between the members A and B, or does not degrade the function or effect demonstrated by the coupling thereof.

Similarly, a “state in which member C is provided between member A and member B” includes a case where the member A and the member C, or the member B and the member C are directly connected, and a case where they are indirectly connected, while placing in between some other member that does not substantially affect the electrical connection state among the members, or does not degrade the function or effect demonstrated by the members.

Dimensions (thickness, length, width, etc.) of the individual members illustrated in the drawings may be appropriately enlarged or shrunk for easy understanding. Furthermore, the dimensions of the plurality of members do not necessarily indicate the dimensional relationship among them, so that a certain member A, if depicted thicker than another member B in a drawing, may even be thinner than the member B.

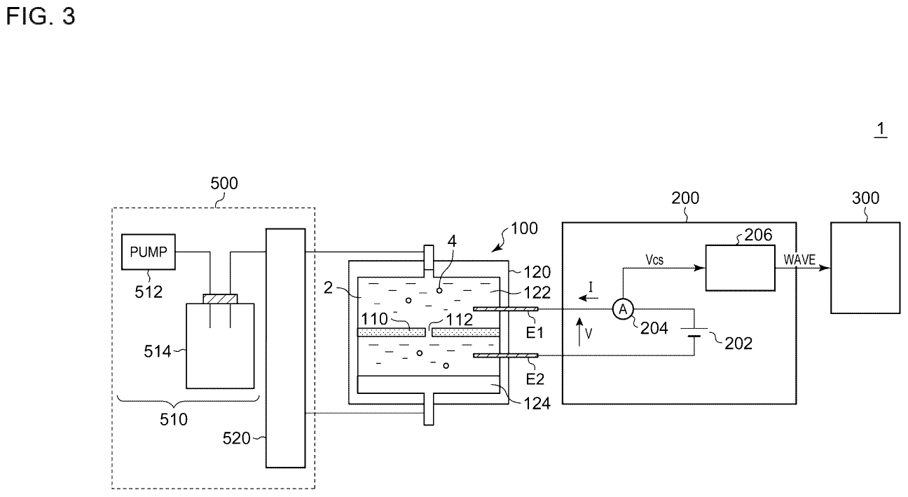

FIG. 3 is a diagram illustrating a microparticle measuring apparatus 1 according to one embodiment. The microparticle measuring apparatus 1 has a pore-based device 100, a measuring instrument 200, a data processor 300, and a pressure controller 500.

The pore-based device 100 has a pore chip 110 and a chip case 120. The pore chip 110 has a pore 112 formed therein. The pore chip 110 is accommodated inside the chip case 120 and partitions the internal space of the chip case 120 into a first liquid chamber 122 and a second liquid chamber 124. The first liquid chamber 122 and the second liquid chamber 124 communicate through the pore 112. The first liquid chamber 122 has a first electrode E1 provided therein, and the second liquid chamber 124 has a second electrode E2 provided therein.

For use in the measurement, the internal space of the chip case 120 is filled with an electrolyte solution 2 that contains particles 4 to be measured.

The measuring instrument 200 is structured to apply voltage V between the first electrode E1 and the second electrode E2, and to measure ion current I flowing between the first electrode E1 and the second electrode E2. The measuring instrument 200 has a voltage source 202, a current detection circuit 204, and a waveform capture module 206. The voltage source 202 is structured to generate potential difference V between the first electrode E1 and the second electrode E2. The current detection circuit 204 is structured to generate a current detection signal Vcs that represents the ion current I flowing from the first electrode E1 to the second electrode E2. The waveform capture module 206 is structured to capture waveform of the current detection signal Vcs. Waveform data WAVE generated by the waveform capture module 206 is transmitted to the data processor 300. The data processor 300 is structured to process the waveform data, and to estimate, for example, the particle size of the particles 4.

Now in advance of explaining a more detailed structure of the microparticle measuring apparatus 1, a problem point in driving a fluid in the pore-based device 100 with a pump will be described.

The present inventors experimentally investigated into an influence of the pump possibly exerted on the current signal to be measured by the measuring instrument 200. In the experiment, the pump was directly connected to the pore-based device 100 (that is, in the absence of a tank described later), and pressure difference was created between two liquid chambers, to measure the current signal.

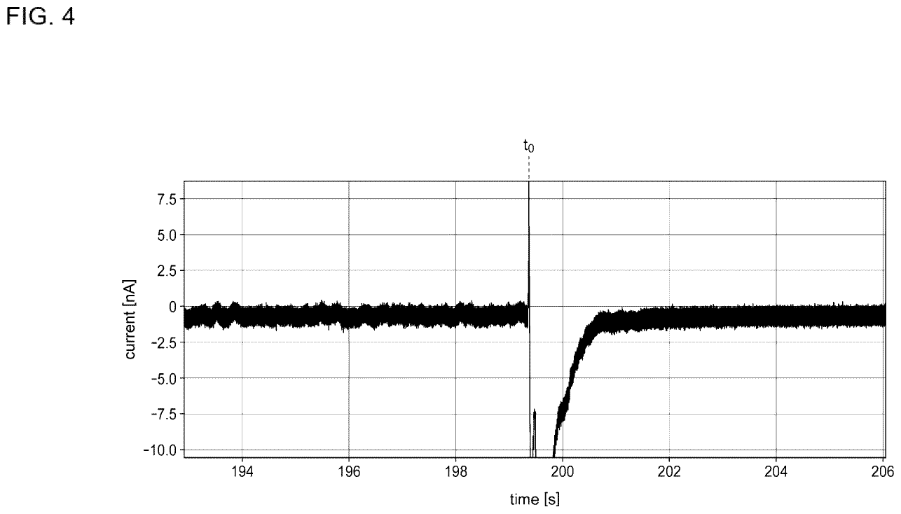

FIG. 4 is a waveform chart (measurement result) of the current signal measured in an operation phase and in a stop phase of the pump. In this experiment, the particles 4 are not present in the electrolyte solution 2. The pump used in the experiment generates a pressure of 0.1 kPa.

A period before time to corresponds to the operation phase of the pump, meanwhile a period after time to corresponds to the stop phase of the pump. The current signal observed during the operating phase of the pump contains pulsation. The pulsation in the current signal presumably occurs according to a mechanism below. An electric pump causes periodical pulsation in the generated pressure, ascribed to its structural reason. This therefore pulsates air pressure applied to the liquid level of the electrolyte solution in the liquid chambers, and such pulsation of the air pressure vibrates the liquid level of the electrolyte solution. Such vibration of the electrolyte solution will appear as fluctuation of the current signal.

Unlike in solid conductors, an internal conductive element (mainly ion) in the electrolyte solution is allowed to constantly fluctuate, rather than being immobilized. As a result of electron exchange by the conductive element at an electrode interface, the current flows between the electrodes.

Vibration of the electrolyte solution will accelerate or decelerate migration of the conductive element. This also causes the conductive element to repetitively come close to, or depart from the electrodes at or around the interface. These events change density of the conductive element at the electrode interface, and fluctuates the amount of electron exchange, that is, the electric current.

In stop phase of the pump after time to, the density of the conductive element at the electrode interface will not fluctuate, so that the current signal will stay constant.

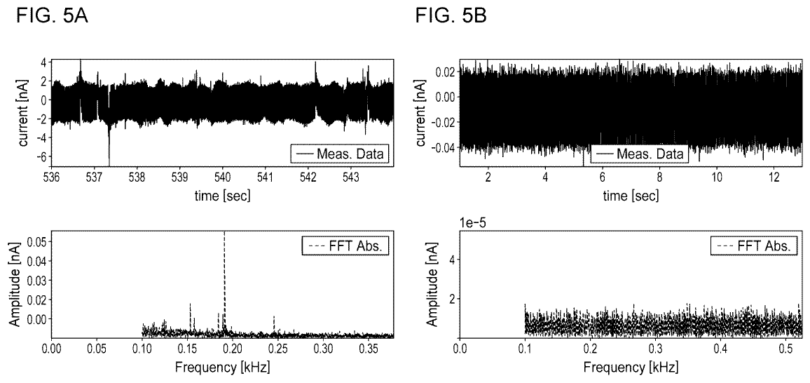

FIG. 5A is a diagram illustrating a current waveform during pump operation (upper tier) and a spectrum thereof (lower tier), meanwhile FIG. 5B is a diagram illustrating a current waveform during pump stop (upper tier) and a spectrum thereof (lower tier). As illustrated in FIG. 5A, an intense spectrum is observed around 0.19 kHz during the pump operation. On the other hand, as illustrated in FIG. 5B, the spectrum ascribed to the pump disappears during the pump stop.

From the experiment, the present inventors have recognized that a spectral component ascribed to the pump degrades the measurement accuracy of the microparticle measurement.

Referring now back to FIG. 3, a structure of the pressure controller 500 for solving this problem will be described.

The pressure controller 500 is structured to control pressure difference between the first liquid chamber 122 and the second liquid chamber 124. The pressure controller 500 has a pressure source 510 and a control valve 520. The pressure source 510 has a pump 512 and a tank 514. The pump 512 is an electric pump. The pump 512 operates prior to the measurement and sends compressed air to the tank 514 to accumulate the pressure. The control valve 520 in this phase is closed, so that the pore-based device 100 is not pressurized. Upon elevation of the pressure in the pump 512 up to a predetermined level, the pump 512 stops.

Upon reaching of the pressure in the tank 514 up to a level necessary for the measurement, the control valve 520 generates the pressure difference between the first liquid chamber 122 and the second liquid chamber 124. With the pressure of the first liquid chamber 122 set higher, the electrolyte solution 2 will flow from the first liquid chamber 122 towards the second liquid chamber 124 through the pore 112. The flow of the electrolyte solution 2 herein serves as driving force for causing the particles 4 to pass through the pore 112.

The structure of the microparticle measuring apparatus 1 has been described. In the microparticle measuring apparatus 1, the tank 514 is provided in the pressure controller 500, in which the pressure generated by the pump 512 in advance of the measurement is accumulated. During the measurement, the pump 512 is stopped, and the pressure difference is created between the first liquid chamber 122 and the second liquid chamber 124, with the aid of the pressure accumulated in the tank 514.

Accordingly, the pressure difference between the first liquid chamber 122 and the second liquid chamber 124 will not pulsate during the measurement, and the flow rate in the pore-based device 100 will be kept substantially constant. This successfully prevents the current signal from being contaminated with noise ascribed to the pump and can improve the measurement accuracy.

It is preferable that the capacity of the tank 514 be at least ten times larger than the volume of a space defined between the pore device 100 and the tank 514. Too large capacity of the tank 514 would, however, take a longer time to adjust the pressure. The tank 514 therefore preferably has a capacity 40 times or smaller the volume of the space defined between the pore-based device 100 and the tank 514. For example, assuming that the volume is 100 μL, the tank 514 will suitably have a capacity of 1 mL to 4 mL.

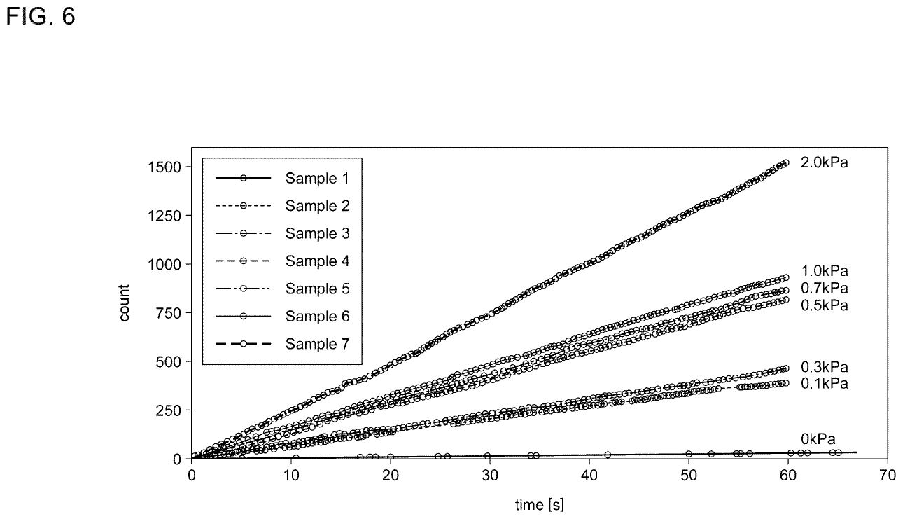

FIG. 6 is a diagram illustrating relationships between the pressure difference and count of passed particles. The abscissa plots time, and the ordinate plots the cumulative pulse count that appears in waveform data, that is, the particle count. The slope represents the number of passed particles per unit time. Accordingly, the larger the pressure difference, the larger the number of passed particles per unit time will be.

Next, an exemplary structure of the measuring instrument 200 will be explained.

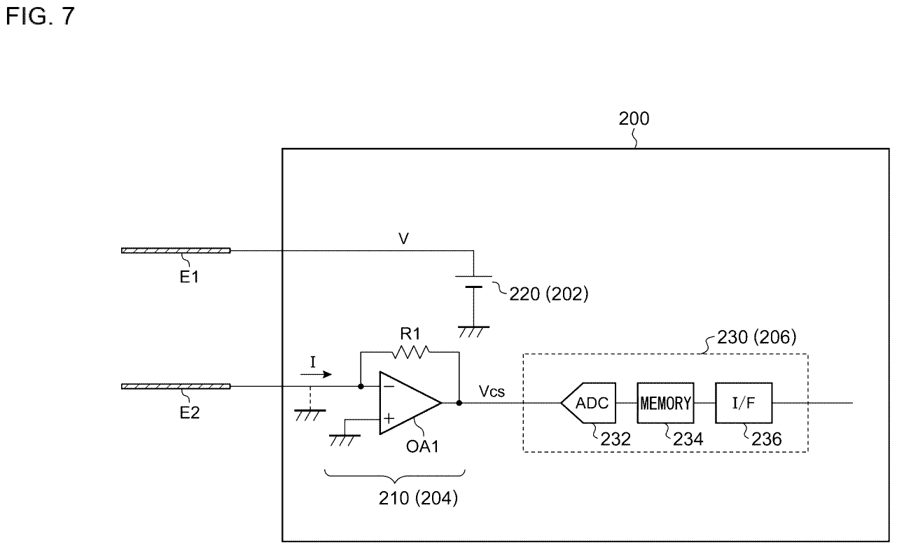

FIG. 7 is a block diagram of a measuring instrument 200 according to one Example. The measuring instrument 200 has the transimpedance amplifier 210, the voltage source 220, and the digitizer 230. The voltage source 220 corresponds to the aforementioned voltage source 202. The transimpedance amplifier 210 corresponds to the aforementioned current detection circuit 204. The digitizer 230 corresponds to the aforementioned waveform capture module 206.

The transimpedance amplifier 210 has an operational amplifier OA1 and a resistor R1. The operational amplifier OA1 has an inverting input terminal coupled to the first electrode E1, and has a non-inverting input terminal grounded. The resistor R1 is connected between the inverting input terminal and an output terminal of the operational amplifier OA1.

The voltage source 220 is structured to apply voltage V to the first electrode E1. With the operational amplifier OA1 virtually grounded, the inverting input terminal, that is, the first electrode E1 will have the ground potential (0 V). Therefore, voltage V is applied between the first electrode E1 and the second electrode E2.

The ion current I flowing from the first electrode E1 to the second electrode E2 flows into the transimpedance amplifier 210. The transimpedance amplifier 210 will have a voltage Vcs represented by:

Vcs=−I×R1,
indicating that the voltage is proportional to the ion current I. The ion current I can therefore be determined by

I=Vcs/R1

The digitizer 230 has an A/D converter 232, a memory 234, and an interface circuit 236. The A/D converter 232 is structured to convert the current detection signal Vcs into a digital signal, at a predetermined sampling period. The memory 234 stores waveform data. The interface circuit 236 is structured to transmit the waveform data stored in the memory 234, to the data processor 300.

The structure of the measuring instrument 200 is not limited to as illustrated in FIG. 7 and may only be a structure capable of measuring impedance between the first electrode E1 and the second electrode E2. The measuring instrument 200, although illustrated in FIG. 7 as of the voltage force current sense (VFIS) type, may alternatively be of the current force voltage sense (IFVS) type. In this case, it suffices that a current source is employed in place of the voltage source 202, and that a voltage detection circuit is employed in place of the current detection circuit 204.

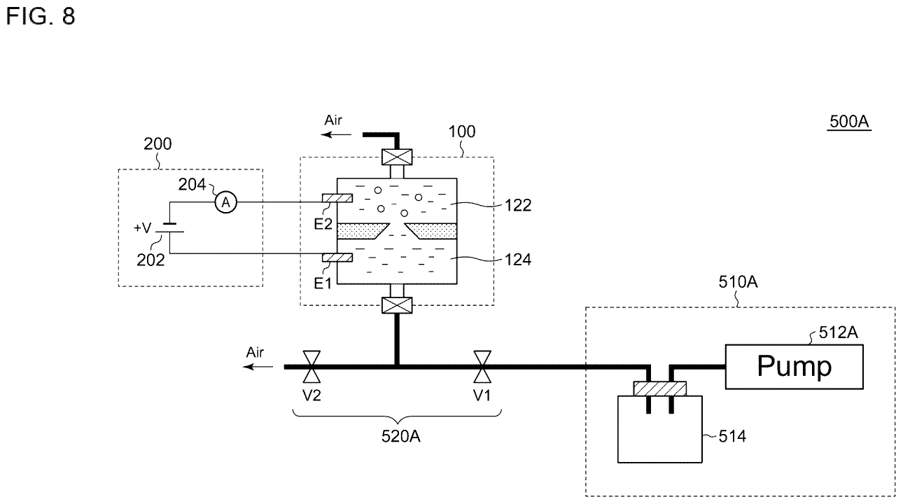

FIG. 8 is a diagram illustrating a pressure controller 500A according to one Example. The pressure controller 500A has a pressure source 510A and a control valve 520A. The pressure source 510A has a pneumatic pump 512A and a tank 514.

The control valve 520A has valves V1 and V2. An air vent for buffering is preferably provided, since sudden switchover of the voltage would damage the pore chip 110.

Before the measurement, the valve V1 is kept closed. Operation of the pump 512 in this state causes the pressure accumulated in the tank 514.

During the measurement, the valve V1 is opened, thereby supplying the pressure in the tank 514 to the second liquid chamber 124. The first liquid chamber 122 is released to the atmospheric pressure. This creates the pressure difference between the first liquid chamber 122 and the second liquid chamber 124.

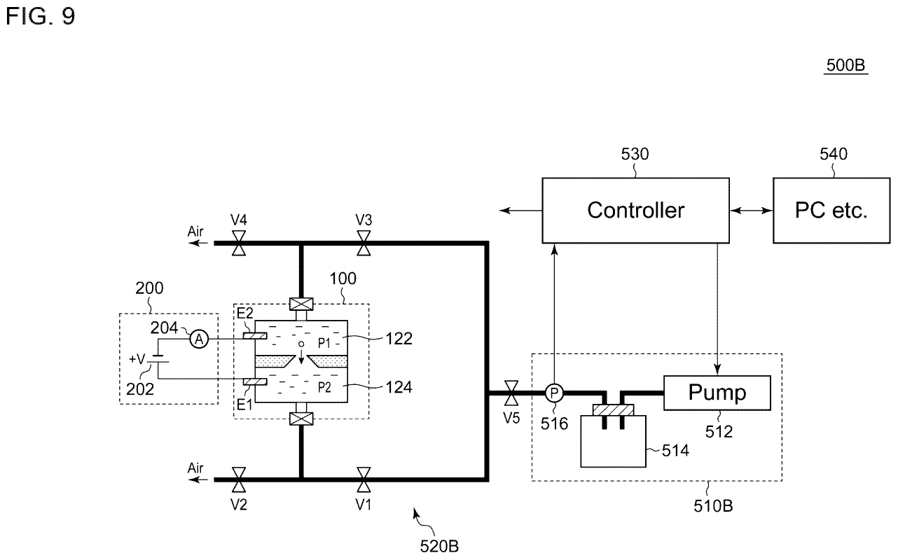

FIG. 9 is a diagram illustrating a pressure controller 500B according to one Example. The pressure controller 500B has a pressure source 510B, a control valve 520B, a controller 530, and a computer 540. The pressure source 510B has the pump 512, the tank 514, and a pressure sensor 516. The pressure sensor 516 is structured to measure the pressure in the tank 514.

The controller 530 is structured to control the control valve 520B constituted by valves V1 to V5, with reference to the pressured sensed by the pressure sensor 516.

Before the measurement, the controller 530 closes the valve V5, and operates the pump 512. Upon arrival of output of the pressure sensor 516 at a predetermined value, the pump 512 is stopped.

Upon start of the measurement, the valve V5 is opened.

The control valve 520B of the pressure controller 500B is structured to enable switching of the direction of pressure applied to the pore-based device 100. More specifically, the pressure controller 500B is structured to repeatedly alternate a first state φ1 in which the pressure p1 of the first liquid chamber 122 is higher, and a second state φ2 in which the pressure p2 of the second liquid chamber 124 is higher, during the measurement. In the first state φ1 where p1>p2 holds, the electrolyte solution 2 moves from the first liquid chamber 122 towards the second liquid chamber 124, along which also the particles 4 contained therein pass through the pore 112 from the first liquid chamber 122 towards the second liquid chamber 124. Conversely, in the second state φ2 where p1<p2 holds, the electrolyte solution 2 moves from the second liquid chamber 124 towards the first liquid chamber 122, along which also the particles 4 contained therein pass through the pore 112 from the second liquid chamber 124 towards the first liquid chamber 122. With the first state φ1 and the second state φ2 thus alternated, the pressure controller 400 reciprocates the particles 4 between the first liquid chamber 122 and the second liquid chamber 124.

In the first state φ1, the valves V2 and V3 are opened, meanwhile the valves V1 and V4 are closed. In the first state φ1, the first liquid chamber 122 is pressurized by the pressure source 510B, meanwhile the second liquid chamber 124 is released to the atmosphere.

In the second state φ2, the valves V1 and V4 are opened, meanwhile the valves V2 and V3 are closed. In the second state φ2, the second liquid chamber 124 is pressurized by the pressure source 510B, meanwhile the first liquid chamber 122 is released to the atmosphere.

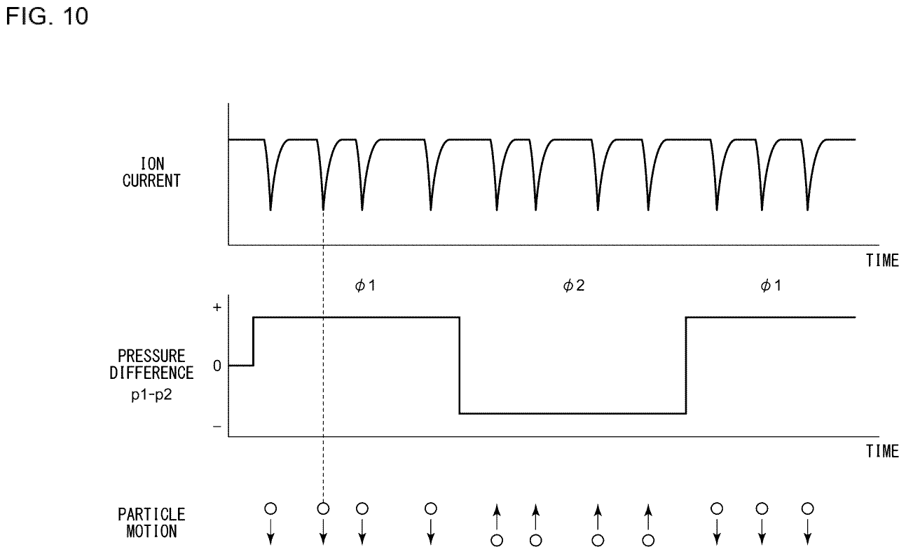

FIG. 10 is a diagram for explaining operations of the pressure controller 500B illustrated in FIG. 9. During the measurement, the first state φ1 and the second state φ2 are repeatedly alternated by the pressure controller 500B. In the first state φ1, the particles 4 flow from the first liquid chamber 122 towards the second liquid chamber 124. When the particle 4 passes through the pore 112, the ion current I decreases in a pulsed manner. The amplitude of the ion current I correlates with the diameter of the particle 4.

During the first state φ1, some particles 4 pass through the pore 112, during which a pulsed change (simply referred to as pulse) appears in the ion current I upon every passage. With the first state φ1 sustained, volume of the electrolyte solution 2 in the first liquid chamber 122 becomes smaller, meanwhile the volume of the electrolyte solution 2 in the second liquid chamber 124 becomes larger. Decrease in the volume of the electrolyte solution 2 in the first liquid chamber 122 to a certain extent causes switchover from the first state φ1 to the second state φ2.

Immediately after the switchover to the second state φ2, the second liquid chamber 124 will have a larger volume of electrolyte solution 2. In the second state φ2, the electrolyte solution 2 is driven from the second liquid chamber 124 towards the first liquid chamber 122, during which the pulse appears in the ion current I every time the particle 4 contained in the electrolyte solution 2 passes the pore 112. With the second state φ2 sustained, volume of the electrolyte solution 2 in the second liquid chamber 124 becomes smaller, meanwhile the volume of the electrolyte solution 2 in the first liquid chamber 122 becomes larger.

In this manner, the pressure controller 500B illustrated in FIG. 9 reciprocates the electrolyte solution 2 between the first liquid chamber 122 and the second liquid chamber 124. This enables acquisition of the waveform data that contains a large number of pulses, even if the electrolyte solution 2 contains only a small number of particles 4. Processing of the thus obtained waveform data enhances probability of statistical processing, thereby improving accuracy of the particle size estimation.

The first state φ1 and the second state φ2 may be switched every time the number of particles 4, having passed through the pore 112, reaches a predetermined number, in other words, every time a predetermined number of pulses appear in the waveform data. The first state φ1 and the second state φ2 may alternatively be switched at a predetermined time interval.

In some cases, the shape at the rise time or the fall time of the pulse that appears in the current signal would vary depending on the direction of passage of the particles, which may be ascribed to the shape of the pore 112 or material of the membrane. Even in these cases, the amplitude of the pulse to be detected remains unchanged, since the maximum resistance value ascribed to the passage of the particles 4 through the pore 112 remains unchanged. The waveform data, obtained both in the first state and the second state, may therefore be equally handled as the data for creating a particle size distribution histogram.

In a case where the direction of the particle 4 is reversed with the aid of electrophoresis, the accuracy of particle size estimation would degrade due to hysteresis in the voltage-current characteristic. In contrast, the embodiment keeps polarity of the voltage applied to the first electrode E1 and the second electrode E2 constant, both in the first state φ1 and the second state φ2. The particle size estimation will, therefore, be not affected by the hysteresis in the voltage-current characteristic and will become accurate.

Note that the pressure controller 500 illustrated in FIG. 9 is not always necessarily required to repeatedly alternate the first state φ1 and the second state φ2, during the measurement. A preferred drive direction of the electrolyte solution would vary, depending on the type and shape of the pore-based device 100 connected to the microparticle measuring apparatus 1. In this case, the user may select either the first state φ1 or the second state φ2, according to the type and shape of the pore-based device 100.

The embodiment has been described. It is to be understood by those skilled in the art that the embodiment is merely illustrative, that the individual constituents or combinations of various processes may be modified in various ways, and that also such modifications fall within the scope of the present disclosure. Such modified examples will be explained below.

Having described herein the microparticle measuring apparatus, the present invention is not limited to this application, or rather widely applicable to measuring instruments responsible for microcurrent measurement for use with the pore-based device, such as DNA sequencer.

Having described the present invention with reference to the embodiment, the embodiment merely illustrates the principle and applications of the present invention, allowing a variety of modifications or layout changes without departing from the spirit of the present invention specified by the claims.

What is claimed is:

1. A microparticle measuring apparatus for use with a pore-based device,
the pore-based device comprising a first liquid chamber and a second liquid chamber separated by a partition having a pore,
the microparticle measuring apparatus comprising:
a measuring instrument structured to measure a current signal flowing between a first electrode provided in the first liquid chamber and a second electrode provided in the second liquid chamber; and
a pressure controller structured to generate pressure difference between the first liquid chamber and the second liquid chamber,
the pressure controller comprising:
a pump; and
a tank connected between the pump and the pore-based device,
and wherein the pump is structured to remain stopped during the measurement.

2. The microparticle measuring apparatus according to claim 1, wherein
the pressure controller further comprises a sensor structured to measure pressure in the tank,
the microparticle measuring apparatus further comprises a controller structured to control the pump in accordance with an output of the sensor, and
the controller is structured to operate the pump prior to the measurement, to stop the pump when the pressure detected by the sensor reaches a predetermined value, and to start the measurement after the pump is stopped.

3. The microparticle measuring apparatus according to claim 1, wherein the pressure controller is structured to reverse a direction of the pressure between the first liquid chamber and the second liquid chamber.

4. The microparticle measuring apparatus according to claim 1, wherein
the measuring instrument comprises:
a transimpedance amplifier structured to convert the current signal into a voltage signal; and
a digitizer structured to convert an output of the transimpedance amplifier into a digital signal.
